(19) United States
(12) Patent Application Publication
(10) Pub. No.: US 2005/0197830 A1
(43) Pub. Date: Sep. 8, 2005

(54) Method for calculating a frame in audio decoding

(76) Inventor: Shih-Sheng Lin, Taipei (TW)

Correspondence Address: BIRCH STEWART KOLASCH & BIRCH, PO BOX 747, FALLS CHURCH, VA, 22040-0747, US

(21) Appl. No.: 10/880,540

(22) Filed: Jul. 1, 2004

(30) Foreign Application Priority Data
Mar. 2, 2004 (TW) 093105404

(51) Int. Cl. G10L 19/00

(52) U.S. Cl. 704/201

(57) ABSTRACT

A method for calculating a frame in audio decoding is described to prevent the decoding error resulted from the calculation error of the frame length due to the misreading of a padding bit in the head information of an audio signal. In the invention, the reading length during decoding can be varied according to a bit stream. By verifying a sync word code or a single word in the bit stream, the header address of the frame can be obtained and thus the head information of the frame can be decoded. Thereby, the real length of the frame can be acquired without referring to the padding bit.

### BACKGROUND OF THE INVENTION

1. Field of the Invention

The present invention relates to a method for calculating a frame in audio decoding, in which a length to be read upon decoding is varied according to the bit data to acquire the real frame length without referring to a padding bit.

2. Description of the Related Art

The Internet shortens distances, making it possible for people to receive all kinds of information and share various data with others. However, due to the limited bandwidth, audio and video files with larger sizes are distributed with difficulty via the Internet. Therefore, MP3 (MPEG Layer 3) compression technology, which is a method for compressing audio data at a compression ratio of up to 12:1 with only little distortion, has been developed. The MP3 technology facilitates Internet data transmission by using a format with a high compression ratio and a small loss of audio quality within the audio sensitivity of human ears. An MP3 decoder is used to decompress an audio file when a user wants to listen to music recorded in the MP3 format. FIG. 1 schematically depicts a block diagram of a prior art MP3 decoder device.

As shown in FIG. 1, an MP3 code 11 converted from any kind of audio sources, such as audio CD or WAV, is input into an MP3 decoder device 10 for decoding, and the resulting signal is output to a loudspeaker end 15, which is an output terminal of a computer system or an MP3 decoder, so that the signal can be heard by a user through an earphone or a speaker. The MP3 decoder device 10 mainly comprises an input stream buffer 12 for receiving data bits, a decoder 13 for decoding the data bits, and an output audio buffer 14 for outputting the decoded audio signals.

In the decompression process of the above MP3 decoder device 10, the frame length for the MP3 bit stream must be calculated and stored in a buffer before decompression begins. Upon calculation of the frame length, a padding bit in the MP3 head information is referred to in order to obtain the correct bit stream. When performing a compression process, if a non-integer sampling frequency, for example, 44.1 kHz, is adopted, the padding bit is set to be “1”, and, if an integer sampling frequency is adopted, the padding bit is left unset, i.e., “0”. Therefore, if there is a misreading of the padding bit, a reading error will occur in the bit stream, and the bit stream will be, for example, one byte short of or one byte over the actual frame length. The incorrect compression data will cause errors in the decoding step and in the frame length calculating step.

The following two paragraphs describe the correct reading of the padding bit.

If the padding bit is “1”, the frame has a length of a non-integer number of bytes, which means an additional byte must be appended to that frame.

If padding bit is “0”, the frame has a length of an integer number of bytes, which means no byte should be appended to that frame.

Two possible errors during decompression are as follows.

Error 1: If a padding bit “0” is mistaken for “1”, then there will be a redundant header of the frame. That is, the buffered data will be one byte larger than the actual frame length, resulting in a decompression error. Moreover, one frame will be skipped in the next frame search.

Error 2: If a padding bit “1” is mistaken for “0”, there will be one byte less than the actual frame length, resulting in a decompression error.

The MP3 compression method is performed on a frame basis and is optimized by using a pointer to indicate where the main data begins. Referring to the schematic frame format of the prior art in FIG. 2A, the bit stream in the MP3 coding is shown to include a first frame 21 and a second frame 22. The first frame 21 comprises a first header 23 occupying a plurality of content bits, a first main data 25 for audio signal, and an unused first spare space 27. The first header 23 is generally divided into a first sync word 23a, other header information 23b, and other side information 23c. Immediately next to the first spare space 27 is the next frame, i.e., the second frame 22. Similar to the first frame 21, the second frame 22 comprises a second header 24, a second main data 26 and a second spare space 28. The second header 24 further includes a second sync word 24a, other header information 24b, and other side information 24c.

In the above frame 21, 22, side information 23c, 24c is provided in the header 23, 24. The main-data-start-pointer points at the spare space 27, 28 of other frames to store a compress file. The spare space 27, 28 in the bit stream is used to increase the compression ratio of MP3 compression. Pointers for indicating start and end information of each audio file are stored in the side information of the header 23, 24. Therefore, the correct audio signal can be generated by decoding if the correct address of the compress file in the bit stream can be obtained by referring to the pointers in the header.

FIG. 2B shows the header bits in the frame according to the prior art. In FIG. 2B, only part of the header in the bit stream is shown and part of the bit pointer is used for illustration purpose. For example, the first frame 21 in FIG. 1A at least includes a sync word 23a and other header information 23b. According to the MP3 coding scheme, the sync word 23a has 12 bits, represented by “111111111111” in binary or “FFF” in hexadecimal, and is used to identify the start of a frame. Other header information 23b includes bits for indicating ID flag 201, layer flag 202, error protection 203, bit rate 204, sampling frequency 205, padding bit 206, private bit 207, mode flag 208, mode expend 209, copyright 210, original copy 211 and emphasis flag 212.

In the method for calculating a frame length according to the prior art, the frame length is acquired by making reference to the information indicated by the above-mentioned pointers of sampling frequency 205, bit rate 204 (i.e., transmission rate of the data bits) and padding bit 206.
Frame Length=Bit Rate×Sampling Frequency×Samples/Frame (Equation 1)

The padding bit is used to verify whether or not the frame contains an integer number of bytes. If the sampling frequency is a non-integer frequency, such as 44.1 kHz, the frame length obtained by Equation 1 will be a non-integer value. Therefore, the padding bit (“0” or “1”) is set to append one byte to the frame; that is, an extra byte is read or the sync word code is verified during decoding. However, if there is a mistake in the padding bit, the calculation result of the real frame length will be incorrect. In the case where a calculation error occurs in the first frame, the sync word and the header of the next frame will certainly be affected, resulting in decoding errors.

In order to prevent decompression errors resulting from the incorrect reading of frame header due to the mistake of the padding bit, the present invention proposes a method for acquiring the real frame length without referring to the padding bit.

### SUMMARY OF THE INVENTION

The present invention relates to a method for calculating a frame in audio decoding. In order to prevent the calculation error of the frame length resulting from the misreading of the padding bit in the header of an audio code, the invention provides a method for acquiring the real frame length without referring to the padding bit by varying the length to be read upon decoding according to the bit data and determining whether a sync word code or a single word is present.

An aspect of the present invention is to provide a method for decoding the frame without referring to a padding bit in the header of the frame. The method for calculating the frame length comprises the steps of: reading data in the former frame and an extra byte-and storing the data and the extra byte into a buffer; verifying presence of a complete sync word code containing words “FFF” or a single word “F”; determining whether the sync word code exists or not; if not, obtaining an address of the header of the frame from the single word “F”; discarding the extra byte stored in the buffer; and decoding the header of the frame. If the words “FFF” are present in the frame, the address of the header of the frame can be obtained.

Another aspect of the present invention is to provide a method for calculating the frame length, which comprises the steps of: reading data in the next frame; verifying an extra word code and determining whether or not the extra word code is a sync word code; if the extra word code is not a sync word code, storing the extra word code into a buffer and carrying out another verifying step; if the extra word code is a sync word code, obtaining an address of the header of the frame; discarding the extra word code stored in the buffer; and decoding the header of the frame.

### BRIEF DESCRIPTION OF THE DRAWINGS

Features and advantages of the present invention will be fully understood from the detailed description to follow taken in conjunction with the examples as illustrated in the accompanying drawings, which are to be considered in all respects as illustrative and not restrictive, wherein:

FIG. 1 schematically depicts a block diagram of an MP3 decoder device according to the prior art;

FIG. 2A is a schematic diagram explaining the frame format according to the prior art;

FIG. 2B is a schematic diagram showing the header bits in the frame according to the prior art;

FIG. 3A is a schematic diagram explaining the frame format according to the present invention;

FIG. 3B is a schematic diagram showing the header format of the frame according to the present invention;

FIG. 4 is a schematic diagram explaining the word-reading process according to the present invention;

FIG. 5 is a flow chart explaining the steps in the first method for calculating a frame in audio decoding according to the present invention; and

FIG. 6 a flow chart explaining the steps in the second method for calculating a frame in audio decoding according to the present invention.

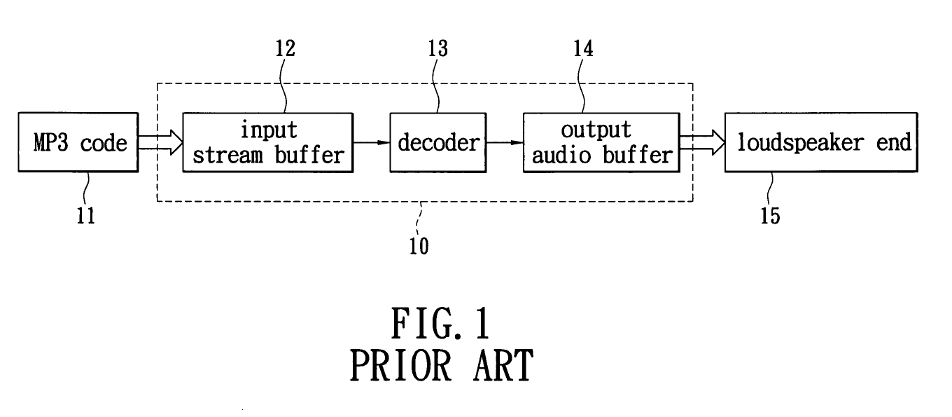

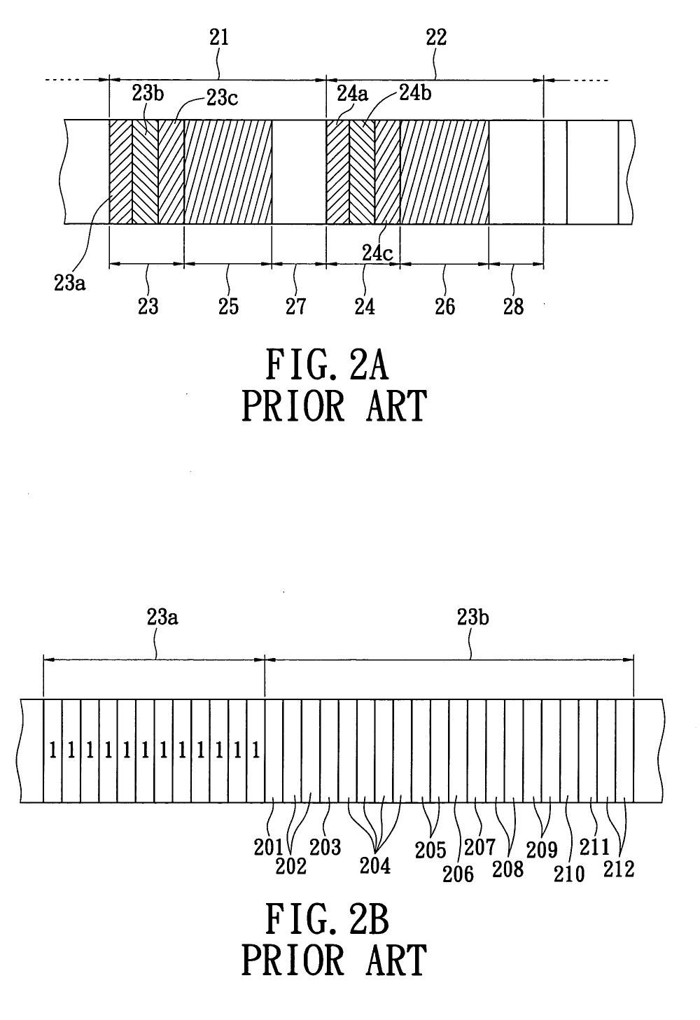

### DETAILED DESCRIPTION OF PREFERRED EMBODIMENTS

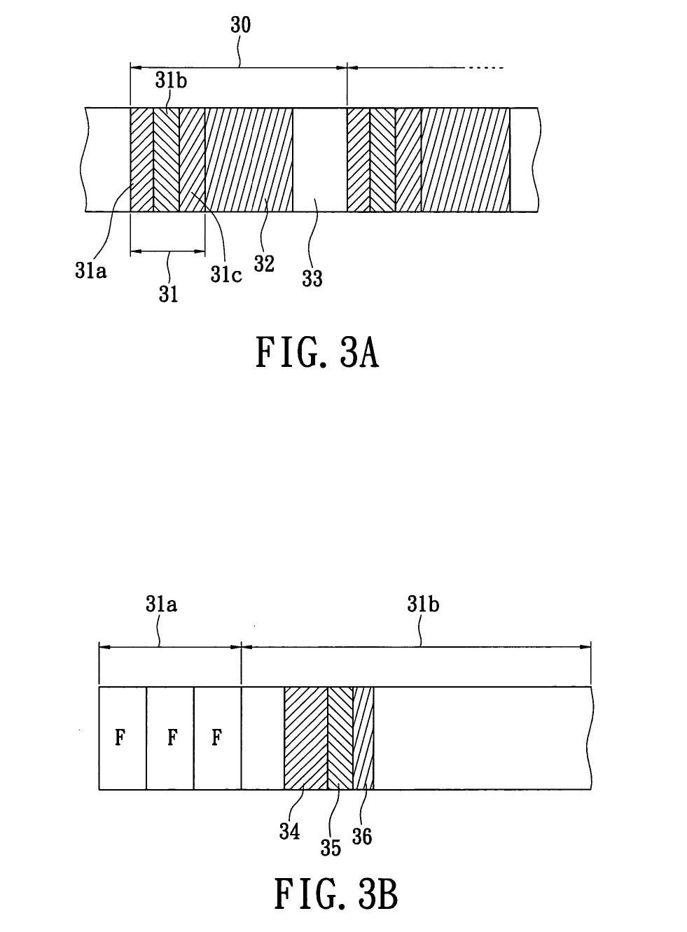

The MP3 compression method is performed on a frame basis. Referring to FIG. 3A, the frame format is shown to comprise a bit stream having a plurality of frames. Each of the frames includes a sync word 31a for indicating the start address of the frame, side information 31c containing information pointers, such as pointers for identifying addresses of the main data or the spare space and flags for recording the sampling frequency and various modes or versions, for a compress file. Following the header 31 are the main data 32, i.e., the location of the audio compress file, and the unused spare space 33. Therefore, the correct audio signal can be generated by decoding if the correct address of the compress file in the bit stream can be obtained by referring to the pointers in the header.

FIG. 3B is a schematic diagram showing the header format of the frame. The header 31 at least includes a sync word 31a and other header information 31b. According to the MP3 coding scheme, the sync word 31a is a word code having 12 bits represented by “111111111111” (or “FFF”) and is used to identify the start of a frame. Upon decoding of an MP3 file, the correct address of a frame is determined by finding the words “FFF”. Other header information 31b includes a plurality of bits for indicating the information of bit rate 34, sampling frequency 35, a padding bit 36 and so on. The basic unit for the frame is a “byte”. Among the information, the padding bit 36 is employed to record whether the frame has a length of a non-integer number of bytes during compression according to the MP3 format. (Please refer to the prior art.)

According to the present invention, the following two methods can be used to prevent the calculation error of the frame length and decompression error resulting from a padding bit mistake.

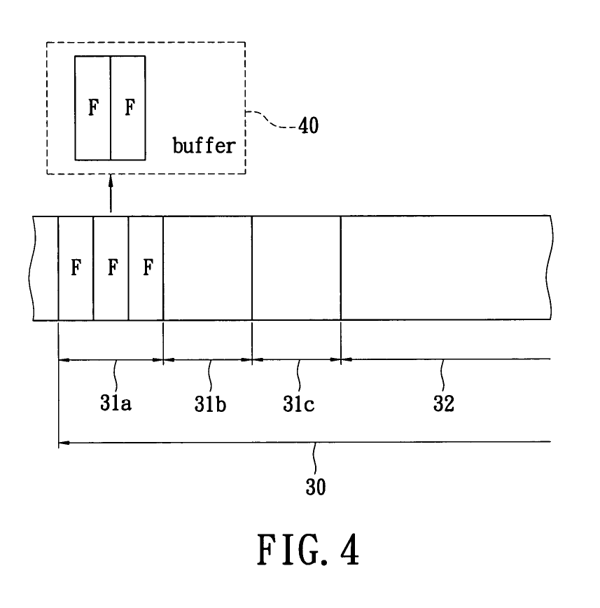

In the first method, the padding bit is ignored and one extra byte (“11111111” or “FF”) is read upon reading a frame, no matter whether the padding bit is “0” or “1”. During MP3 decoding, the extra byte is stored in a buffer. In the case where the frame 30 has a length of a non-integer number of bytes so that an additional byte must be appended to the frame, since an extra byte has been read into the buffer 40, the original method for identifying the sync word is not affected and finding the words “FFF” means finding the sync word. In the case where the frame has a length of an integer number of bytes, since the words “FF” have been read into the buffer 40, as shown in FIG. 4, finding a single word “F” means finding a “sync word”. Provided that the sync word is found, the header of the frame can be defined. Accordingly, the header information can be decoded and thus the MP3 audio signal can be decoded.

In the second method, the padding bit is ignored but no extra byte is read, which is different from the first method. However, upon reading the start of the next frame, an extra word code is verified. If the extra word code is not a sync word, i.e., “FFF”, then this byte is stored into the buffer and another verifying step is carried out.

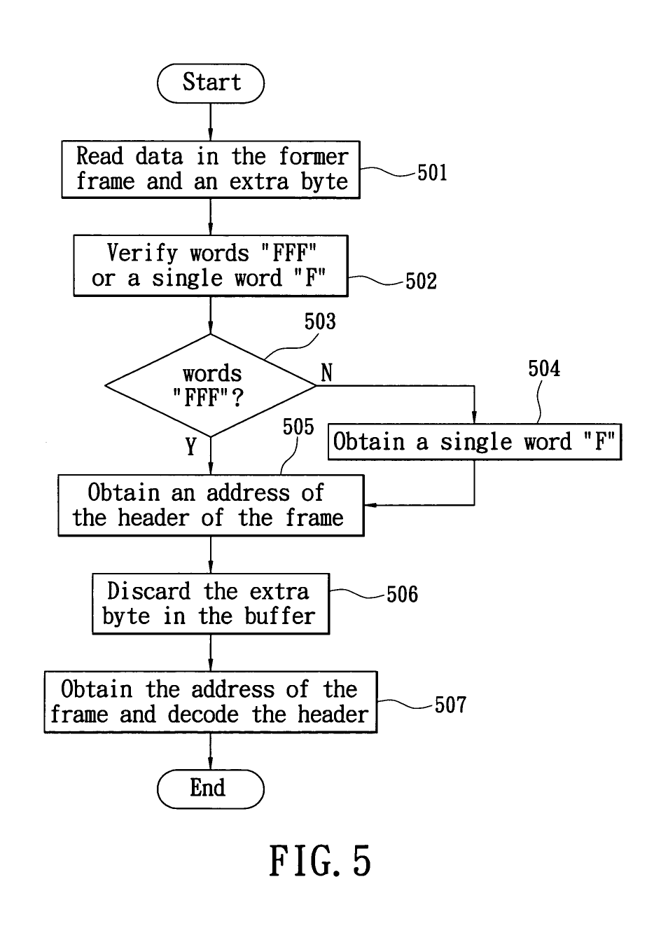

FIG. 5 shows a flow chart explaining the steps in the first method for calculating a frame in audio decoding according to the present invention.

(Step 501) A frame is the basic unit in an MP3 bit stream. The frame comprises a header, a main data and a spare space, recorded in sequence. At the beginning of the audio decoding, in order to calculate the length of the current frame, the first step is to read data in the former frame and an extra byte and store the data and the extra byte into a buffer in order to determine the address of the current frame.

(Step 502) Then, whether a complete sync word code containing words “FFF” or a single word “F” is present in the bit stream is verified.

(Step 503) Whether the sync word code exists or not is determined.

(Step 504) If the sync word does not exist, then the frame has a length of an integer number of bytes. Since a byte “FF” has been read into the buffer, only a single word “F” is present.

(Step 505) An address of the header of the frame from the single word “F” is obtained so as to define the length of the frame.

(Step 505) If the words “FFF” are present, then the frame has a length of a non-integer number of bytes. The position of the sync word, i.e., “FFF”, is the position of the header of the frame. Thereby, the length of the frame can be acquired.

(Step 506) Then, since the length of the frame has been acquired, the extra byte stored in the buffer in step 501 can be discarded.

(Step 507) Since the length of the frame is acquired, the header information can be decoded and thus the MP3 audio signal can be decoded.

Decoding of the frame is finished.

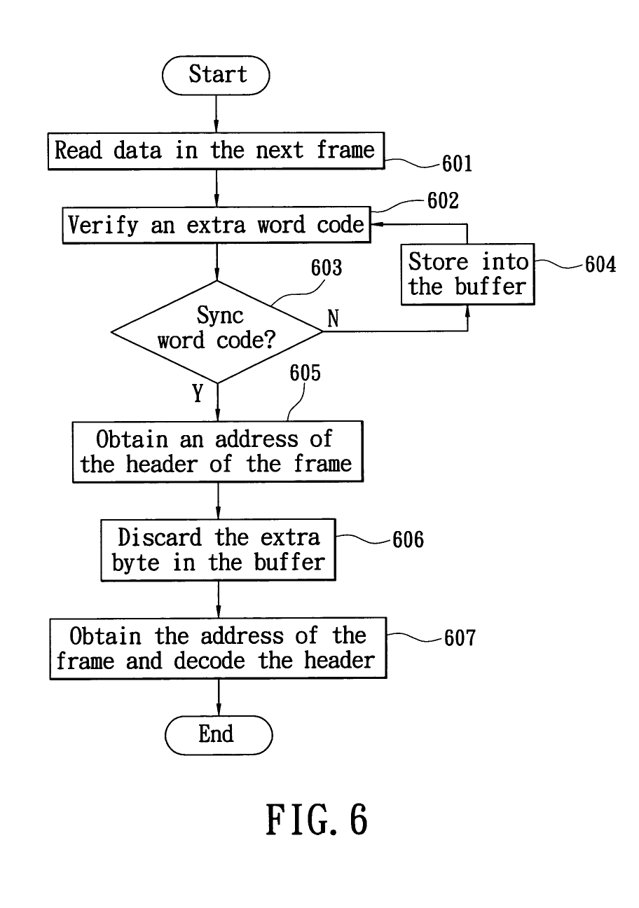

FIG. 6 shows a flow chart explaining the steps in the second method for calculating a frame in audio decoding according to the present invention.

(Step 601) A frame is the basic unit in an MP3 bit stream. The frame comprises a header, a main data and a spare space, recorded in sequence. At the beginning of the audio decoding, in order to calculate the length of the current frame, the first step is to read data in the next frame.

(Step 602) An extra word code is verified.

(Step 603) Whether or not the extra word code is a sync word code is determined.

(Step 604) If the extra word code is not a sync word code, the extra byte is stored into a buffer and the verification step of step 602 is repeated.

(Step 605) If the sync word code “FFF” is present, then the frame has a length of a non-integer number of bytes, and the position of the sync word “FFF” is the position of the header of the frame. Thereby, the length of the frame can be acquired.

(Step 606) Then, since the length of the frame has been acquired, the extra byte stored in the buffer in step 602 can be discarded.

(Step 607) Since the length of the frame is acquired, the header information can be decoded and thus the MP3 audio signal can be decoded.

The decoding of the frame is finished.

In summary, the present invention provides a method for calculating a frame in audio decoding, in which an extra byte of data is read during decoding to obtain the real length of the frame without referring to the padding bit, so that the error resulted from the misreading of a padding bit can be prevented.

While the present invention has been described with reference to the detailed description and the drawings of the preferred examples thereof, it is to be understood that the invention should not be considered as limited thereby. Various modifications and changes could be conceived of by those skilled in the art without departuring from the scope of the present invention, which is indicated by the appended claims.

1. A method for calculating a frame in audio decoding for decoding said frame without referring to a padding bit in a header of said frame, said frame being a basic unit of MP3 format, said method comprising the steps of:
reading data in a former frame and an extra byte and storing the data and said extra byte into a buffer;
verifying a presence of a complete sync word code containing words “FFF” or a single word “F”;
determining whether said sync word code exists or not;
if said sync word does not exist, obtaining an address of said header of said frame from said single word “F”;
discarding said extra byte stored in said buffer; and
decoding said header of said frame.

2. The method for calculating a frame in audio decoding of claim 1, wherein, in the step of determining whether said sync word code exists or not, if said sync word code exists, said position is said header of said frame and the length of said frame is acquired.

3. The method for calculating a frame in audio decoding of claim 1, wherein, in the step of determining whether said sync word code exists or not, if said sync word code does not exist, said frame has a length of an integer number of bytes.

4. The method for calculating a frame in audio decoding of claim 1, wherein, in the step of determining whether said sync word code exists or not, if said sync word code exists, said frame has a length of a non-integer number of bytes.

5. The method for calculating a frame in audio decoding of claim 1, wherein said frame at least includes said header, a side information and a main data.

6. The method for calculating a frame in audio decoding of claim 5, wherein said side information at least includes bits for indicating a padding bit, a sampling frequency and a bit rate.

7. A method for calculating a frame in audio decoding, comprising the steps of:
reading data in a former frame and an extra byte;
verifying presence of a complete sync word code containing words “FFF” or a single word “F”;
obtaining an address of said header of said frame;
decoding said header of said frame.

8. The method for calculating a frame in audio decoding of claim 7, wherein said frame has a length of an integer number of bytes if said single word “F” is present.

9. The method for calculating a frame in audio decoding of claim 7, wherein said frame has a length of a non-integer number of bytes if said sync word code is present.

10. The method for calculating a frame in audio decoding of claim 7, wherein said frame at least includes said header, a side information and a main data.

11. A method for calculating a frame in audio decoding for decoding said frame without referring to a padding bit in a header of said frame, said frame being a basic unit of MP3 format, said method comprising the steps of:
reading data in a next frame;
verifying an extra word code;
determining whether said extra word code is a sync word code;
if said extra word code is a sync word code, thereby acquiring a length of said frame;
discarding said extra word code;
obtaining an address of said header of said frame; and
decoding said header of said frame.

12. The method for calculating a frame in audio decoding of claim 11, wherein, in the step of determining whether said extra word code is a sync word code, if said extra word code is not a sync word code, said extra word code is stored into a buffer and another verifying step is carried out.

13. The method for calculating a frame in audio decoding of claim 11, wherein said frame at least includes said header, a side information and a main data.

14. The method for calculating a frame in audio decoding of claim 13, wherein said side information at least includes bits for indicating a padding bit, a sampling frequency and a bit rate.
